(19) United States
(12) Patent Application Publication
(10) Pub. No.: US 2016/0339618 A1
(43) Pub. Date: Nov. 24, 2016

(54) HEATING SLEEVE FOR INJECTION MOLDING NOZZLE

(71) Applicant: Synventive Molding Solutions, Inc., Peabody, MA (US)

(72) Inventor: Vito Galati, Rowley, MA (US)

(21) Appl. No.: 15/228,066

(22) Filed: Aug. 4, 2016

Related U.S. Application Data
(63) Continuation of application No. PCT/US15/18243, filed on Mar. 2, 2015.
(60) Provisional application No. 61/947,589, filed on Mar. 4, 2014.

(51) Int. Cl. B29C 45/17; B29C 45/76; B29C 45/03; B29C 45/74

(52) U.S. Cl. CPC B29C 45/1782; B29C 45/74; B29C 45/7613; B29C 45/03; B29K 2105/0067

(57) ABSTRACT

An injection molding system comprising:
a manifold,
a nozzle comprising a nozzle body having an outer circumferential surface that reduces in cross-sectional diameter or radial length beginning from a selected upstream point to a selected downstream point,
a sleeve having a hollow bore having an inner surface complementary to the outer circumferential surface of the nozzle body such that the downstream end of the nozzle body is insertable into the upstream end of the hollow bore and further insertable downstream through the hollow bore to a point of maximum downstream travel at which the outside circumferential surface of the nozzle body engages the inside surface of the hollow bore, the engaged surfaces preventing further downstream travel of the sleeve body through the hollow bore.

### RELATED APPLICATIONS

This application is a continuation of and claims the benefit of priority to international application PCT/US15/18243 filed Mar. 2, 2015 which claims the benefit of priority to U.S. Provisional Application Ser. No. 61/947,589 filed Mar. 4, 2014, the disclosures of both of which are incorporated by reference in their entirety as if fully set forth herein.

The disclosures of all of the following are incorporated by reference in their entirety as if fully set forth herein: International Application Publication No. WO2012/074879, U.S. Patent Application Publication No. 2012/0248644, International Application Publication No. 2012/087491, U.S. Patent Application Publication No. 2012/0248652, U.S. Pat. No. 5,894,025, U.S. Pat. No. 6,062,840, U.S. Pat. No. 6,294,122, U.S. Pat. No. 6,309,208, U.S. Pat. No. 6,287,107, U.S. Pat. No. 6,343,921, U.S. Pat. No. 6,343,922, U.S. Pat. No. 6,254,377, U.S. Pat. No. 6,261,075, U.S. Pat. No. 6,361,300 (7006), U.S. Pat. No. 6,419,870, U.S. Pat. No. 6,464,909 (7031), U.S. Pat. No. 6,599,116, U.S. Pat. No. 7,234,929 (7075US1), U.S. Pat. No. 7,419,625 (7075US2), U.S. Pat. No. 7,569,169 (7075US3), U.S. patent application Ser. No. 10/214,118, filed Aug. 8, 2002 (7006), U.S. Pat. No. 7,029,268 (7077US1), U.S. Pat. No. 7,270,537 (7077US2), U.S. Pat. No. 7,597,828 (7077US3), U.S. patent application Ser. No. 09/699,856 filed Oct. 30, 2000 (7056), U.S. patent application Ser. No. 10/269,927 filed Oct. 11, 2002 (7031), U.S. application Ser. No. 09/503,832 filed Feb. 15, 2000 (7053), U.S. application Ser. No. 09/656,846 filed Sep. 7, 2000 (7060), U.S. application Ser. No. 10/006,504 filed Dec. 3, 2001, (7068) and U.S. application Ser. No. 10/101,278 filed Mar. 19, 2002 (7070), U.S. Pat. No. 8,297,836 (7087), U.S. Pat. No. 8,328,549 (7096) and international applications PCT/US2011/062099 (7100) and PCT/U52011/062096 (7100).

### BACKGROUND OF THE INVENTION

Injection molding systems using sleeves as heating mechanisms that surround the central fluid passage of an injection nozzle in an injection molding system have been used as described in U.S. Pat. No. 8,297,836 where heating coils and thermocouples are wrapped together in a helix around or within a sleeve that is stationarily attached to the nozzle.

### SUMMARY OF THE INVENTION

In accordance with the invention there is provided an injection molding system 10 comprising:
a manifold 24 having a flow channel 27 receiving a stream of injection fluid,
a nozzle comprising a nozzle body 18 having an upstream end 18U, a downstream end 18D and a flow passage 21 having an axial length NAL sealably communicating at the upstream end with the flow channel of the manifold for delivering the injection fluid downstream to the cavity 12c of a mold 12, the nozzle body 18 having an outer circumferential surface OCS that reduces in cross-sectional diameter or radial length D1-D2 beginning from a selected upstream point USP to a selected downstream point DSP along at least a portion AL of the axial length NAL of the flow passage 21,
a sleeve heatable to an elevated temperature, the sleeve being comprised of a sleeve body 20 having a hollow bore 20B having an upstream end 20U, a downstream end 20D and an axial length AL, the hollow bore 20B having an inner surface IS complementary to the outer circumferential surface OCS of the nozzle body 18 such that the downstream end 18D of the nozzle body is insertable into the upstream end of 20U the hollow bore 20B and further insertable downstream through the hollow bore to a point of maximum downstream travel at which the outside circumferential surface OCS of the nozzle body engages the inside surface IS of the hollow bore 20B, the engaged surfaces preventing further downstream travel of the sleeve body 20 through the hollow bore 20B.

The inner surface IS of the sleeve body that is complementary to the outer surface preferably reduces in diameter D1-D2 beginning from a selected upstream point downstream to a selected downstream point along the axial length of the hollow bore.

Such a system preferably further comprises a spring S that is adapted to constantly urge the sleeve 20 in an upstream direction with an upstream directed force UF relative to the nozzle body to maintain the inner surface IS of the sleeve body in mating contact with the outer circumferential surface OCS of the nozzle body 18.

The spring is typically adapted to bear against the nozzle in a downstream direction to exert the upstream directed force against the sleeve.

The spring is typically compressed or compressible to exert the upstream directed force.

The spring can be mounted between opposing surfaces of or fixedly interconnected to the nozzle body and the sleeve such that the spring can be compressed to exert an upstream directed force against the sleeve body and an opposing downstream directed force against the nozzle body.

The outer circumferential surface of the nozzle body that reduces in diameter or radial length is preferably generally conical in configuration.

The inside surface of the sleeve body that reduces in diameter or radial length is preferably generally conical in configuration.

Such a system typically further comprises a heating element disposed helically around the flow passage of the nozzle body in contact with at least one of the sleeve body or the nozzle body along a selected portion AL or all of the axial length NAL of the nozzle passage. A terminal end of the thermocouple can be disposed distally of the terminal end of the heater element.

The heating element can be disposed a radial distance apart from a central axis of the flow passage that reduces in radial distance going from upstream toward downstream along the axial distance.

The heating element can be disposed a uniform radial distance apart from a central axis of the flow passage along the axial distance.

The heating element can be embedded within either the sleeve body or the nozzle body.

Such a system can further comprise a thermocouple element disposed helically around the flow passage of the nozzle body.

The heating element HE and the thermocouple element TE can be disposed within a tube 60, 60′ that is disposed helically around the flow passage 21 of the nozzle body in contact with at least one of the sleeve body or the nozzle body along the selected axial distance, the terminus HEP of the heating element and the terminus T of the thermocouple element being disposed at least about 0.125 inches axially apart from each other.

The helical tube can be embedded within either the sleeve body or the nozzle body.

In another aspect of the invention there is provided a method of heating a nozzle of a system as described above, the method comprising mating the outer circumferential surface of the nozzle body with the inside surface of the sleeve body and heating the sleeve body to an elevated temperature.

In another aspect of the invention there is provided a method of heating a nozzle in an injection molding apparatus comprised of:
a manifold having a flow channel receiving a stream of injection fluid,
a nozzle comprising a nozzle body having an upstream end, a downstream end and a flow passage having an axial length sealably communicating at the upstream end with the flow channel of the manifold for delivering the injection fluid downstream to the cavity of a mold, the nozzle body having an outer circumferential surface that reduces in cross-sectional diameter or radial length beginning from a selected upstream point to a selected downstream point along at least a portion of the axial length of the flow passage,
a sleeve heatable to an elevated temperature, the sleeve comprising a sleeve body having a hollow bore having an upstream end, a downstream end and an axial length, the hollow bore having an inner surface complementary to the outer circumferential surface of the nozzle body such that the downstream end of the nozzle body is insertable into the upstream end of the hollow bore and further insertable downstream through the hollow bore to a point of maximum downstream travel at which the outside circumferential surface of the nozzle body engages the inside surface of the hollow bore, the engaged surfaces preventing further downstream travel of the sleeve body through the hollow bore,
wherein the method comprises:
inserting the downstream end of the nozzle body axially into the upstream end of the hollow bore of the sleeve,
moving the sleeve axially upstream to surround the outer circumferential surface of the nozzle body along a predetermined axial length of the nozzle body extending up to an upstream position where the inner surface of the hollow bore mates or engages with the outer circumferential surface of the nozzle body such that the sleeve is prevented from further upstream movement.

Such a method can further comprise heating the sleeve body to an elevated temperature.

Such a method can further comprise constantly urging the sleeve body in an upstream direction with an upstream force to maintain the inner surface of the sleeve in mating contact with the outer circumferential surface of the nozzle.

Such a method can further comprise helically winding a heating element around the outside surface of the nozzle and extending the helically wound heating element along a selected axial length of the nozzle.

Such a method can further comprise helically winding a thermocouple element around the outside surface of the nozzle and extending the helically wound thermocouple element along a selected axial length of the nozzle.

Such a method can further comprise forming the outer circumferential surface that reduces in cross-sectional diameter or radial length to be generally conical.

Such a method can further comprise forming the inner surface that reduces in cross-sectional diameter or radial length to be generally conical.

Such a method can further comprise mounting a spring to the nozzle and arranging the spring to bear against the nozzle under compression to exert a constant upstream directed force on the sleeve body.

In another aspect of the invention there is provided an injection molding system comprising:
a manifold having a flow channel receiving a stream of injection fluid,
a nozzle comprising a nozzle body having an upstream end, a downstream end and a flow passage having an axial length sealably communicating at the upstream end with the flow channel of the manifold for delivering the injection fluid downstream to the cavity of a mold, the nozzle body having a conical outer circumferential surface that reduces in cross-sectional diameter or radial length beginning from a selected upstream point to a selected downstream point along at least a portion of the axial length of the flow passage,
a sleeve comprised of a sleeve body having a hollow bore having an upstream end, a downstream end and an axial length, the hollow bore having a conical inner surface complementary to the outer circumferential surface of the nozzle body such that the downstream end of the nozzle body is insertable into the upstream end of the hollow bore and further insertable downstream through the hollow bore to a point of maximum downstream travel at which the outside circumferential surface of the nozzle body engages the inside surface of the hollow bore, the engaged surfaces preventing further downstream travel of the sleeve body through the hollow bore,
a spring adapted to constantly urge the sleeve in an upstream direction with an upstream directed force relative to the nozzle body to maintain the inner surface of the sleeve body in mating contact with the outer circumferential surface of the nozzle body.

In another aspect of the invention there is provided an injection molding system comprising:
a manifold having a melt channel receiving a melt stream of injection fluid,
a nozzle comprising an elongated tubular body having a hollow central injection fluid passage sealably communicating with the the melt channel for delivering the injection fluid to the cavity of a mold,
the nozzle passage having a central axis,
the tubular body having an upstream end, a downstream end and an outer circumferential surface that continuously reduces in cross-sectional diameter from the upstream end toward the downstream end,
a sleeve comprising a tubular body having a selected axial length, an upstream end and a downstream end and a central hollow bore having an inner surface that continuously reduces in cross-sectional diameter from its upstream end toward its downstream end,
the outer circumferential surface of the nozzle and the inner surface of the sleeve being complementary in contour to each other such that the downstream end of the nozzle is axially insertable into the upstream end of the central hollow bore of the sleeve, the sleeve being movable axially upstream to surround the outer circumferential surface of the nozzle along a predetermined axial length of the nozzle extending up to an upstream position where the inner surface of the sleeve mates or engages with the outer circumferential surface of the nozzle such that the sleeve is prevented from further upstream movement.

Such an apparatus can further comprise a spring that constantly urges the sleeve in an upstream direction with an upstream force to maintain the inner surface of the sleeve in mating contact with the outer circumferential surface of the nozzle.

The apparatus can further comprise a heating wire helically wound around or embedded within the outside surface of the nozzle or embedded within the inside surface of the sleeve extending along a selected axial length of the nozzle.

The apparatus can further comprise a thermocouple wire helically wound around or embedded within the outside surface of the nozzle or embedded within the inside surface of the sleeve extending a selected axial length of the nozzle.

The outside surface of the nozzle can be generally conical in configuration. The inside surface of the sleeve can be generally conical.

The spring can be mounted to the nozzle and arranged to bear against the nozzle under compression to exert the upstream force on the sleeve.

In another aspect of the invention there is provided a method of heating a nozzle in an injection molding apparatus comprising:
a manifold having a melt channel receiving a melt stream of injection fluid,
a nozzle comprised of an elongated tubular body having a hollow central injection fluid passage sealably communicating with the melt channel for delivering the injection fluid to the cavity of a mold wherein the nozzle passage has a central axis,
the tubular body having an upstream end, a downstream end and an outer circumferential surface that continuously reduces in cross-sectional diameter from the upstream end toward the downstream end,
a sleeve comprising a tubular body having a selected axial length, an upstream end and a downstream end and a central hollow bore having an inner surface that continuously reduces in cross-sectional diameter from its upstream end toward its downstream end,
the outer circumferential surface of the nozzle and the inner surface of the sleeve being complementary in contour to each other,
wherein the method comprises:
inserting the downstream end of the nozzle axially into the upstream end of the central hollow bore of the sleeve,
moving the sleeve axially upstream to surround the outer circumferential surface of the nozzle along a predetermined axial length of the nozzle extending up to an upstream position where the inner surface of the sleeve mates or engages with the outer circumferential surface of the nozzle such that the sleeve is prevented from further upstream movement.

Such a method preferably further comprises constantly urging the sleeve in an upstream direction with an upstream force to maintain the inner surface of the sleeve in mating contact with the outer circumferential surface of the nozzle.

Such a method typically further comprises selecting the nozzle or the sleeve to include a heating wire helically wound around or embedded within the outside surface of the nozzle or embedded within the inside surface of the sleeve and extending along a selected axial length of the nozzle.

Such a method typically further comprises selecting the nozzle or the sleeve to include a thermocouple wire helically wound around or embedded within the outside surface of the nozzle or embedded within the inside surface of the sleeve and extending a selected axial length of the nozzle.

Such a method typically further comprises selecting the nozzle such that the outside surface of the nozzle is generally conical.

Such a method typically further comprises selecting the sleeve such that the inside surface of the sleeve is generally conical.

Such a method typically further comprises mounting a spring to the nozzle and arranging the spring to bear against the nozzle under compression to exert the upstream force on the sleeve.

### BRIEF DESCRIPTION OF THE DRAWINGS

The above and further advantages of the invention may be better understood by referring to the following description in conjunction with the accompanying drawings in which:

FIG. 1 is a top isometric schematic overview of an injection molding apparatus including one embodiment of a heating apparatus according to the invention.

FIG. 2 is a side cross-sectional view of a nozzle with a heating sleeve mounted around the outside circumferential surface of the nozzle with the heating coils and thermocouple spaced a varying radial distance from the axis along the length of the axis of the flow passage of the nozzle according to the invention.

FIG. 2A is a side cross-sectional view similar to FIG. 2 with the heating coils and thermocouple spaced a uniform radial distance from the axis along the length of the axis of the flow passage of the nozzle according to the invention.

FIG. 3 is a perspective view of a sleeve 40 similar to the sleeve 20 shown in the FIG. 2 apparatus showing the location of the tube containing the heater coil and thermocouple wire embedded within and adjacent the inner surface IS of the cast-sheath or sleeve 40;

FIG. 3A is a schematic side cross-sectional view of the distal end of the sleeve or cast of FIG. 3.

### DETAILED DESCRIPTION

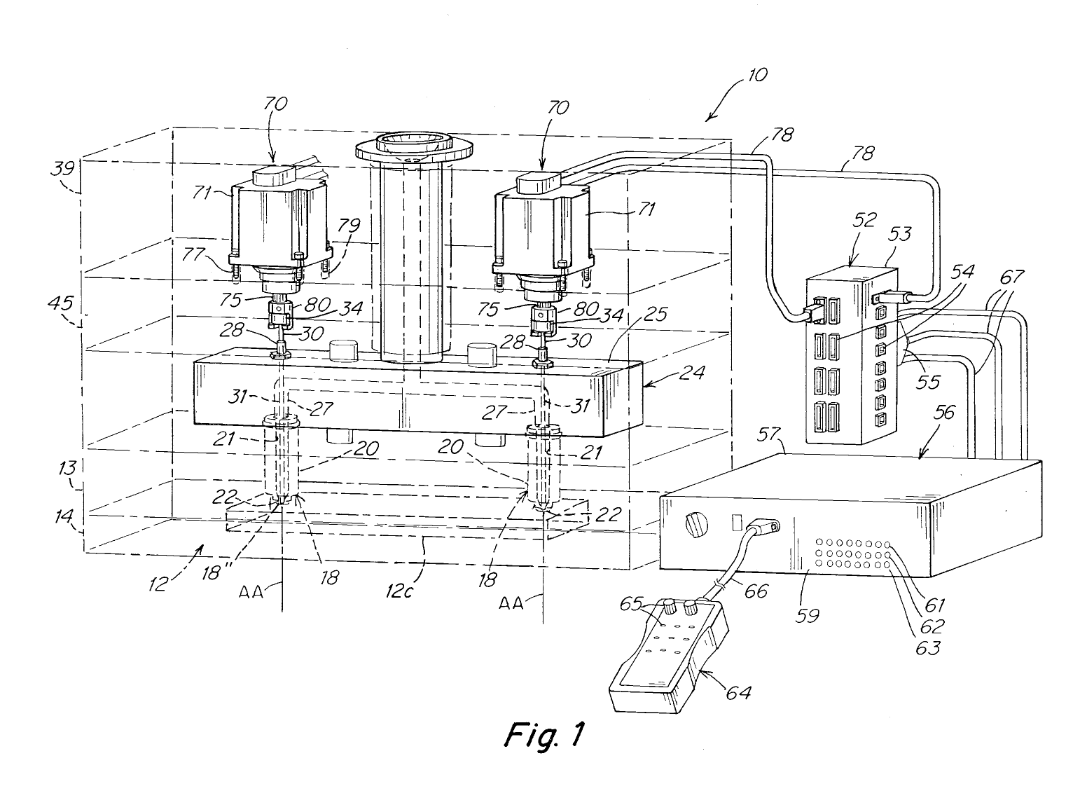

FIG. 1 is an overview of one configuration of an injection molding apparatus that can incorporate a heating sleeve and complementary nozzle configuration according to the invention. The system 10 shown in FIG. 1 includes a series of layered components forming a stack. Here the component layers of the stack are shown vertically arranged, one on top of another, although in use the entire stack, hotrunner or manifold 24, top clamp plate 39, mold 12 other components as shown would typically mounted rotated 90°. For ease of description, the stack is described as a vertical stack even through in use it is not so disposed. At one end of the stack, here referred to as the bottom end of the stack, a mold 12 has a cavity 12c for receiving hot molten plastic fed through a gate 20 of an injection nozzle 18. The nozzle 18 is mounted in association with one or more metal (e.g. stainless steel) plates, including a heated manifold 24 and one or more other spacer, mounting or mold plates 13, 14. The manifold 24 is heated to maintain the injection fluid delivered to the nozzle 18 at an elevated temperature for delivery of the molten plastic. The mold cavity and plates 13, 14 are relatively cool compared to the manifold 24 to enable solidification of the injected molten plastic to form a solid plastic article within the cavity of the mold.

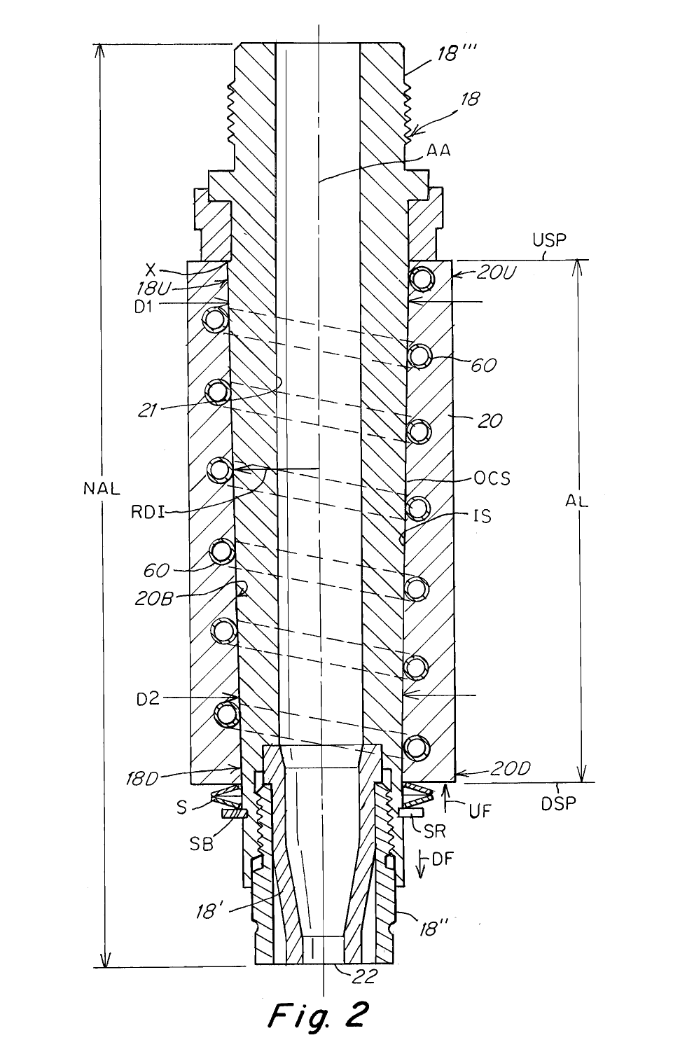

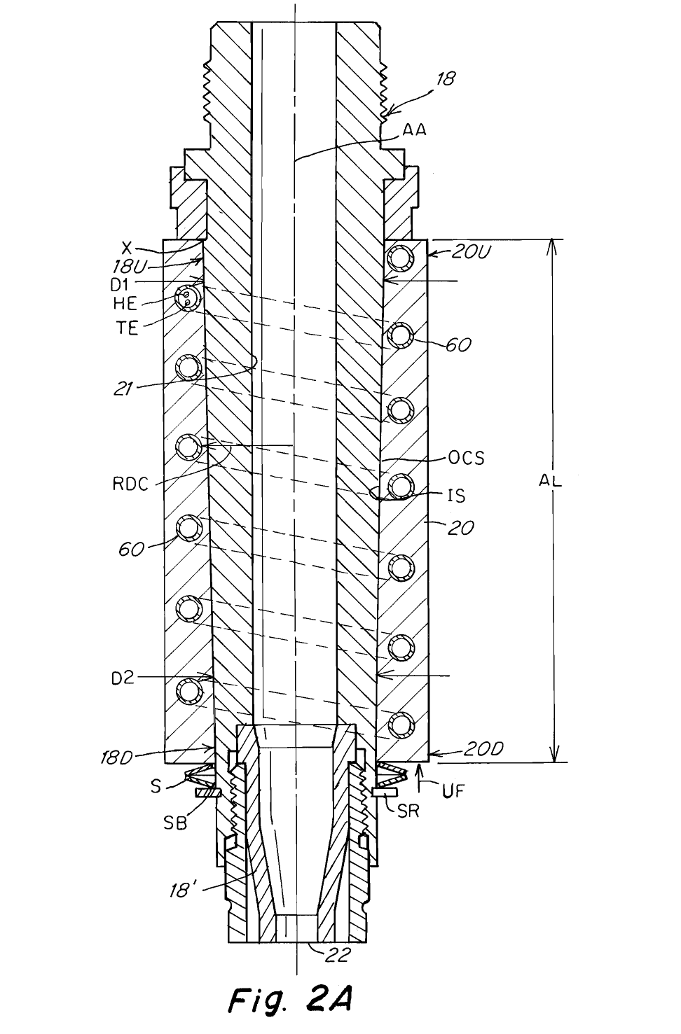

The nozzle 18 described in detail below comprises an elongated tube typically made of stainless steel and having a central axial bore 21 through which the molten plastic delivered to bore 21 from the manifold 24 travels to the gate 20 and into the mold cavity. Also in the nozzle bore, aligned along the central bore axis, is an axially elongated valve pin 30 having an axially elongated stem 31, which defines the valve pin and nozzle bore 21 axis AA. At one end of the stem, designed to seat and unseat in the nozzle gate for purposes of opening and closing the gate, and effectively starting and stopping flow of the molten plastic to the mold cavity, the stem typically has an angular or tapered lowermost tip that is complementary to a tapered inner surface of an insert 18″ mounted within the distal downstream end of the nozzle 18, FIG. 2. At the opposite or upstream (top) end of the valve stem is a pin head adapted to couple and decouple with an actuator 70, the actuator being a mechanism for driving the valve pin along an axial path of travel AA typically substantially coincident with the central axial bore AA of the nozzle 18 which is substantially coincident with the pin axis AA. The valve stem also extends through an elongated plastic feed bore 27 in the heated manifold 24, typically also substantially coaxial with the nozzle bore. The valve stem is guided into and mounted to the manifold 24 by a bushing 28 which receives, guides and mounts the valve stem 31 in the manifold plastic fluid flow bore 27. The pin head 34 extends axially upstream beyond and from the bushing on the upstream or top side 25 of the manifold.

The pin head may be formed integral with the valve stem (as a single part) or it may be formed as a separate part and then secured to the upper or top end of the valve stem. It may or may not be radially enlarged but is typically formed in a radially enlarged configuration for ease of ready connectivity to and disconnectivity from an adapter component as described below.

In the FIG. 1 embodiment, above/upstream of the manifold 24, a pair of upper and lower mounting plates 39, 45 are provided in or on which the actuator 70 is mounted. The plates 39 and 45 are sometimes referred to as top clamping plates, clamping plates or backing plates. The actuator 70 can be a linear actuator, such as an electrically powered motor actuator, for driving the valve pin stem axially (linearly) along the coaxial bores of the manifold and nozzle 18. The actuator can alternatively comprise a hydraulically or pneumatically driven actuator having an actuating member such as a piston that is reciprocally drivable along an axial path of travel by hydraulic or pneumatic fluid. In embodiments where the actuator comprises an electric motor, the motor is enclosed in a housing 71 which is typically disposed within a receiving aperture or chamber 40 in the upper mounting plate 39 and/or a chamber 40a in the lower mounting plate 45. Where the actuator is a hydraulic or pneumatic device, a similar housing for the driven actuating member is provided. In the embodiment shown, the housing 71 is fixed to the lower mounting plate 45 by threaded bolts 77 which extend into complementary threaded holes 50 in plate 45 so as to removably couple the actuator housing 71 to the mounting plate 39 (see FIG. 5). The mounting plates 39, 45 are removably coupled to the mold typically by bolts or similar reversible fastening mechanisms. The chamber 40 of the upper mounting plate 39 (in which the motor housing 71 is disposed) is actually a through bore in the upper plate 39 extending from the top surface 42 to the bottom surface 43.

An actuator coupling 80 is attached to or mounted on the actuator shaft 75 and is also disposed in the bore of the lower mounting plate 39 when the actuator is connected to the mounting plate. The actuator coupling includes a radial recess 83, disposed laterally (traverse to the elongated valve pin axis.

Also in the FIG. 1 embodiment, the actuator 70 is interconnected to a controller 56. In this embodiment, the actuator is an electric motor having a linearly drivable shaft for engaging the pin head for axial movement of the valve stem in the manifold and nozzle so as to open and close the nozzle opening at the gate, by seating and unseating the valve stem tip in the gate. Controlling the valve stem position in the gate can be important for creating clean injection molded parts without residues of undesired plastic, and to avoid freezing or closing off the gate with solidified plastic. In this embodiment, an electronic controller 56 is provided which monitors and controls the operation of the actuator, and thus axial movement of the actuator shaft and valve stem. A pair of electrical cables 78 connect the actuator motor 70 to a junction box 52. The junction box can be mounted in the mounting plates, along with the motor. This allows the actuator motor to remain with the mounting plates when they are (together) removed from the manifold, leaving behind the valve stem extended into the manifold and nozzle, and while leaving the electrical actuator wired to the junction box 52. The junction box housing 53 includes a series of electrical connectors 54 for receiving the electrical cables from the motor, and other connectors 55 for electrical cables 67 connecting the junction box to the controller for transmitting control signals from the controller. A user hand-held input device 64 is connected (via cable 66) to the front face 59 of the controller box 57 for inputting instructions (via hand-held buttons and knobs 65) to the controller regarding operation of the valve stem. In this embodiment, the control system includes sensors for monitoring the position of the valve pin in the gate, and resetting that position if it deviates from a desired position. The controller box 57 has a three series of LEDS for each of 8 actuators, the upper series 61 indicating “valve gate opened”, the middle series 62 indicating “valve gate enabled”, and the lower series 63 indication “valve gate closed.” Control signals, and feedback sensor signals are transmitted to and from the controller for monitoring and adjusting the pin position during the injection molding cycle. The sensitivity of these adjustments, which must be transmitted via the drive shaft to the valve pin, make the structure and function of the coupling adapter of particular importance in the present embodiment. The coupling adapter can isolate both undesirable mechanical effects (e.g., vibration, rotation) and thermal effects from interfering with this sensitive control operation.

FIG. 2 shows an embodiment of a nozzle 18 and sleeve 20 where the diameter D2 of the outside circumferential surface OCS of the nozzle 18 toward the downstream end 18D is smaller than the diameter D1 toward the upstream end 18U, the contour of the outside circumferential surface OCS being adapted such that the cross-sectional diameter continuously reduces from the upstream end toward the downstream end typically in a conical surface configuration. The sleeve 20 has a selected axial length AL, an upstream end 20U and a downstream end 20D and a central hollow bore 20B having an inner surface IS that continuously reduces in cross-sectional diameter from its upstream end toward its downstream end in a complementary fashion to the configuration of the outside circumferential surface OCS of nozzle 18. The outer circumferential surface OCS of the nozzle 18 and the inner surface IS of the sleeve 20 are adapted to be complementary in contour to each other such that the downstream end 18D of the nozzle 18 is axially insertable into the upstream end 20U of the central hollow bore of the sleeve, the sleeve 20 being movable axially upstream to surround the outer circumferential surface OCS of the nozzle along a predetermined axial length of the nozzle extending up to an upstream position X where the inner surface IS of the sleeve 20 mates or engages with the outer circumferential surface OCS of the nozzle 18 such that the sleeve 20 is prevented from further upstream movement.

As shown in the FIG. 2 embodiment a spring S is mounted downstream of the distal end surface 20DS of the sleeve and is adapted to exert a constant upstream force UF on the sleeve so as to maintain the upstream end 20u of the sleeve 20 in its upstream-most position X and to maintain the inside surface IS in constant mating engagement with the outside surface OCS of the nozzle 18. In the embodiment of FIG. 2, the spring S comprises a leaf spring having a bottom end downstream facing surface SB mounted to and engaged against a top upstream facing surface of an O-ring, washer or other suitable mount mechanism SR that can mount the spring S for upstream forcible exertion UF against the sleeve 20 to constantly urge the sleeve 20 under force UF in an axially upstream direction as well as urge the nozzle 18 under force DF in an axially downstream direction such that the surfaces OCS and IS are maintained under and in compressed heat conductive contact.

Also as shown in the FIG. 2 embodiment, a tube 60 containing a heater wire or heater element HE and thermocouple wire or element TE extending throughout the length of the helical tube 60 is shown helically wrapped around the nozzle 18. The tube 60 is typically embedded within the body of the sleeve 20 such that the tube 60 closely abuts or is disposed closely adjacent the outer circumferential surface OCS of the nozzle. Thus the heater wire and thermocouple wires (not shown) that are disposed within the tube 60 and extending helically around the nozzle 18 from downstream end to upstream end are disposed within the tube 60 at an increasing radial distance RDI away from the axis AA starting from the downstream end 20D of the sleeve 20 axially upstream along the axis AA toward the upstream end 20U of the sleeve. In other words, the heater wire and thermocouple become increasingly distant RDI from axis AA travelling upstream from downstream end to upstream end.

As shown in the FIG. 2A alternative embodiment, the tube 60 can be disposed around the passage 21, typically by being embedded within the body of the sleeve 20 itself, extending from the downstream end 18D toward the upstream end 18U in a helical arrangement similar to the arrangement shown in FIG. 2. In such an embodiment, the helical tube 60 is disposed within the body of the nozzle 18 such that the tube 60 is disposed at a uniform or constant radial distance RDC away from the axis AA starting from the downstream end 18D of the nozzle axially upstream along the axis AA toward the upstream end 18U.

As shown in FIGS. 2, 2A, the nozzle or nozzle body 18 typically includes a nozzle tip 18′, 18″ which is typically screwably connected to the downstream end of an upstream body portion 18′″, one or the other of the nozzle tip components 18′, 18″ typically being comprised of relatively low thermally conductive materials in order to insulate the gate 22 from heat emanating from the heated upstream body portion 18′″.

In the FIGS. 2, 2A embodiments, the cross-sectional diameter or radial distance between axis AA and the outer circumferential surface OCS of the nozzle or nozzle body 18 reduces in diameter or radial distance along an axial distance AL which comprises a portion of the overall axial length NAL of the nozzle body 18. The cross-sectional diameter or radial length continuously reduces starting axially from the selected upstream point USP downstream to the selected downstream point along the axial length NAL of the nozzle body 18. Similarly, the cross-sectional diameter or radial length between axis AA and the interior surface IS of the sleeve body 20 reduces in diameter or radial length beginning from the selected upstream point USP to the downstream point DSP along the axial length AL of the sleeve 20.

As shown in FIGS. 2, 2A, the downstream end 18D of the nozzle body has been inserted into the upstream end 20U of the central hollow bore 21 of the sleeve 20 and the nozzle body 18 has been further fully inserted downstream through the bore 21 to the maximum downstream position shown in FIGS. 2, 2A where the inner surface IS mates with the outer circumferential surface OCS and the interior surface IS prevents the nozzle body 18 from any further downstream travel by virtue of the interference fit between the interior surface IS of the sleeve 20 and the outer circumferential surface OCS of the nozzle 18 body at the maximum downstream travel position of the nozzle body 18 within the sleeve bore 21.

As shown the axial upstream directed force UF exerted by the spring S on the downstream distal end 20D of the sleeve together with the simultaneous axial downstream directed force DF exerted against the downstream end 18D of the nozzle 18 through the washer SR that is interconnected to the downstream end 18D of the nozzle body serves to maintain the sleeve 20 and the nozzle body 18 in a position under force UF, DF where the outside circumferential surface OCS and the inner surface IS are held in compressed intimate engagement or metal-to-metal contact such that the two surfaces OCS and IS create or enable maximum transfer of heat from the sleeve body 20 to the nozzle body 18. The nozzle body 18 and the sleeve body 20 are preferably comprised of highly heat conductive metal materials while the nozzle tip component 18″ that is typically physically engaged or in contact with the body of the mold 12 at the gate 22 is preferably comprised of a relatively low heat conductive or non-heat conductive material in order to attempt to insulate transmission of heat from the heated nozzle body 18 to the cooled mold body 12, FIGS. 1, 2.

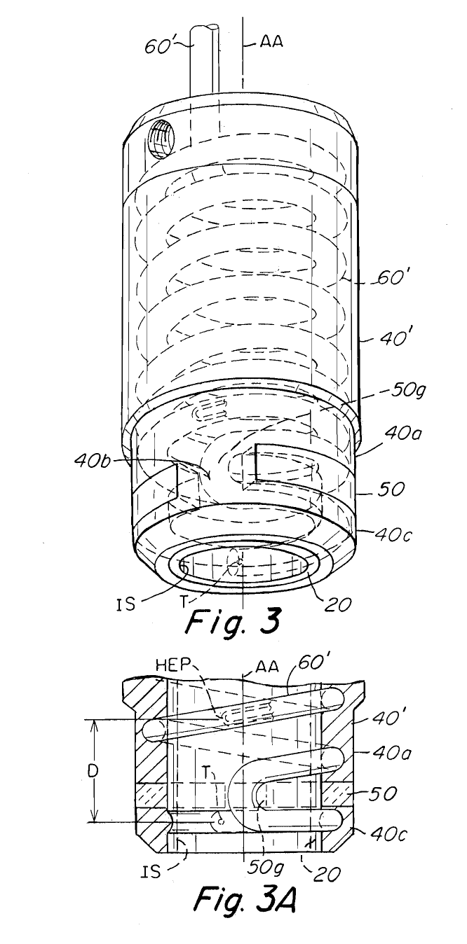

In the FIGS. 3, 3A alternative embodiment, a sleeve 20′, 40′ surrounding the outer circumferential surface of a nozzle body (not shown) such as surface OCS and nozzle 18 of FIG. 2 comprises a solid cast material 40′ and an inner tube 20′ around which the cast 40′ is mounted both of which are collectively disposed around the outer circumferential surface OCS of a nozzle 18. A helical tube 60′ containing a heater wire and a thermocouple wire is embedded within the body of the cast material 40′ and extends axially AA about the entire axial length AL of the cast material 40.′ The inside surface IS of the inner tube 20′ makes contact with the outer circumferential surface of an associated in the same manner as described with reference to sleeve 20 and nozzle 18 of FIG. 2 namely that the nozzle tubular body has an outer circumferential surface that continuously reduces in cross-sectional diameter from its upstream end toward its downstream end, the sleeve 20′, 40′ has an inner surface IS that continuously reduces in cross-sectional diameter from its upstream end toward its downstream end and the outer circumferential surface of the nozzle and the inner surface of the sleeve are complementary in contour to each other such that the downstream end of the nozzle is axially insertable into the upstream end of the central hollow bore of the sleeve, the sleeve being movable axially upstream to surround the outer circumferential surface of the nozzle along a predetermined axial length of the nozzle extending up to an upstream position where the inner surface of the sleeve mates or engages with the outer circumferential surface of the nozzle such that the sleeve is prevented from further upstream movement.

In a most preferred embodiment, the helical tube 60′ is embedded within the cast material 40′ such that the axis of the tube 60′ and the heater and thermocouple wires disposed within the tube 60′ are disposed at an increasing radial distance away from the axis AA starting from the downstream end of the cast material 40′ axially upstream along the axis AA toward the upstream end of the cast material. In other words, the heater wire and thermocouple become increasingly distant from axis AA travelling upstream from downstream end to upstream end.

In the FIGS. 3, 3A embodiment, a thermal insulator 50 can be mounted on or to the heated body of cast material 40′ and/or the heated body of the heater tube 20′ in an arrangement that, except for a small portion 40b of the cast material residing in a circumferential gap 50g of the insulator 50, substantially separates physical engagement or contact between an upstream heated body portion 40a of the cast material (and its associated tube 20′) and the downstream selected body portion 40c of the cast material (and its associated heater tube 20′) which the sensor T of the thermocouple is in immediate adjacency to and/or contact with. Such substantial physical separation results in substantial thermal isolation and/or separation of the sensor T from the much larger heated body portions 40a of the cast material and its associated upstream heated portions of the heater tube 20. In the FIGS. 3, 3A embodiment the heater element and the thermocouple element are housed or contained within the helical tube that helically extends around the flow passage 21 of the nozzle. The terminus or end point HEP of the heater element and the terminus or end sensor point T of the thermocouple are preferably spaced a distance D of at least about 0.125 inches or greater away from each other in the axial direction along the axis AA of the nozzle. Preferably the distance D is between about 0.125 and about 0.5 inches and most preferably between about 0.125 and about 0.375 inches.

What is claimed is:

1. An injection molding system comprising:
a manifold having a flow channel receiving a stream of injection fluid,
a comprising a nozzle body having an upstream end, a downstream end and a flow passage having an axial length sealably communicating at the upstream end with the flow channel of the manifold for delivering the injection fluid downstream to the cavity of a mold, the nozzle body having an outer circumferential surface that reduces in cross-sectional diameter or radial length beginning from a selected upstream point to a selected downstream point along at least a portion of the axial length of the flow passage,
a sleeve heatable to an elevated temperature, the sleeve being comprised of a sleeve body having a hollow bore having an upstream end, a downstream end and an axial length, the hollow bore having an inner surface complementary to the outer circumferential surface of the nozzle body such that the downstream end of the nozzle body is insertable into the upstream end of the hollow bore and further insertable downstream through the hollow bore to a point of maximum downstream travel at which the outside circumferential surface of the nozzle body engages the inside surface of the hollow bore, the engaged surfaces preventing or opposing further downstream travel of the nozzle body through the hollow bore,
a spring adapted to constantly urge the sleeve body in an upstream direction with an upstream directed force relative to the nozzle body to maintain the inner surface of the sleeve body in mating contact with the outer circumferential surface of the nozzle body.

2. The system of claim 1 wherein the inner surface of the sleeve body that is complementary to the outer surface reduces in diameter beginning from a selected upstream point downstream to a selected downstream point along the axial length of the hollow bore.

3. The system of claim 1 wherein the spring is adapted to bear against the nozzle in a downstream direction to exert a downstream directed force against the nozzle body.

4. The system of claim 3 wherein the spring is compressed to exert the upstream directed force.

5. The system of claim 2 wherein the spring is mounted between opposing surfaces of or fixedly interconnected to the nozzle body and the sleeve such that the spring can be compressed to exert an upstream directed force against the sleeve body and an opposing downstream directed force against the nozzle body.

6. The system of claim 1 wherein the outer circumferential surface of the nozzle body that reduces in diameter or radial length is generally conical in configuration.

7. The system of claim 1 wherein the inside surface of the sleeve body that reduces in diameter or radial length is generally conical in configuration.

8. The system of claim 1 further comprising a heating element disposed helically around the flow passage of the nozzle body in contact with at least one of the sleeve body or the nozzle body along a selected axial distance.

9. The system of claim 8 wherein the heating element is disposed a radial distance apart from a central axis of the flow passage that reduces in radial distance going from upstream toward downstream along the axial distance.

10. The system of claim 8 wherein the heating element is disposed a uniform radial distance apart from a central axis of the flow passage along the axial distance.

11. The system of claim 8 wherein the heating element is embedded within either the sleeve body or the nozzle body.

12. The system of claim 8 further comprising a thermocouple element disposed helically around the flow passage of the nozzle body.

13. The system of claim 12 wherein the heating element and the thermocouple element are disposed within a tube that is disposed helically around the flow passage of the nozzle body in contact with at least one of the sleeve body or the nozzle body along the selected axial distance, the terminus of the heating element and the terminus of the thermocouple element being disposed at least about 0.125 inches axially apart from each other.

14. The system of claim 13 wherein the tube is embedded within either the sleeve body or the nozzle body.

15. A method of heating a nozzle of a system according to claim 1 comprising mating the outer circumferential surface of the nozzle body with the inside surface of the sleeve body and heating the sleeve body to an elevated temperature.

16. A method of heating a nozzle in an injection molding apparatus comprised of:
a manifold having a flow channel receiving a stream of injection fluid,
a nozzle comprising a nozzle body having an upstream end, a downstream end and a flow passage having an axial length sealably communicating at the upstream end with the flow channel of the manifold for delivering the injection fluid downstream to the cavity of a mold, the nozzle body having an outer circumferential surface that reduces in cross-sectional diameter or radial length beginning from a selected upstream point to a selected downstream point along at least a portion of the axial length of the flow passage,
a sleeve heatable to an elevated temperature, the sleeve comprising a sleeve body having a hollow bore having an upstream end, a downstream end and an axial length, the hollow bore having an inner surface complementary to the outer circumferential surface of the nozzle body such that the downstream end of the nozzle body is insertable into the upstream end of the hollow bore and further insertable downstream through the hollow bore to a point of maximum downstream travel at which the outside circumferential surface of the nozzle body engages the inside surface of the hollow bore, the engaged surfaces preventing further downstream travel of the sleeve body through the hollow bore,
wherein the method comprises:
inserting the downstream end of the nozzle body axially into the upstream end of the hollow bore of the sleeve,
moving the sleeve axially upstream to surround the outer circumferential surface of the nozzle body along a predetermined axial length of the nozzle body extending up to an upstream position where the inner surface of the hollow bore mates or engages with the outer circumferential surface of the nozzle body such that the sleeve is prevented from further upstream movement.

17. The method of claim 16 further comprising heating the sleeve body to an elevated temperature.

18. The method of claim 16 further comprising constantly urging the sleeve body in an upstream direction with an upstream force to maintain the inner surface of the sleeve in mating contact with the outer circumferential surface of the nozzle.

19. The method of claim 16 further comprising helically winding a heating element around the outside surface of the nozzle and extending the helically wound heating element along a selected axial length of the nozzle.

20. The method of claim 16 further comprising helically winding a thermocouple element around the outside surface of the nozzle and extending the helically wound thermocouple element along a selected axial length of the nozzle.

21. The method of claim 16 further comprising forming the outer circumferential surface that reduces in cross-sectional diameter or radial length to be generally conical.

22. The method of claim 16 further comprising forming the inner surface that reduces in cross-sectional diameter or radial length to be generally conical.

23. The method of claim 16 further comprising mounting a spring to the nozzle and arranging the spring to bear against the nozzle under compression to exert a constant upstream directed force on the sleeve body.

24. An injection molding system comprising:
a manifold having a flow channel receiving a stream of injection fluid,
a nozzle comprising a nozzle body having an upstream end, a downstream end and a flow passage having an axial length sealably communicating at the upstream end with the flow channel of the manifold for delivering the injection fluid downstream to the cavity of a mold, the nozzle body having a conical outer circumferential surface that reduces in cross-sectional diameter or radial length beginning from a selected upstream point to a selected downstream point along at least a portion of the axial length of the flow passage,
a sleeve comprised of a sleeve body having a hollow bore having an upstream end, a downstream end and an axial length, the hollow bore having a conical inner surface complementary to the outer circumferential surface of the nozzle body such that the downstream end of the nozzle body is insertable into the upstream end of the hollow bore and further insertable downstream through the hollow bore to a point of maximum downstream travel at which the outside circumferential surface of the nozzle body engages the inside surface of the hollow bore, the engaged surfaces preventing further downstream travel of the sleeve body through the hollow bore,
a spring adapted to constantly urge the sleeve in an upstream direction with an upstream directed force relative to the nozzle body to maintain the inner surface of the sleeve body in mating contact with the outer circumferential surface of the nozzle body.
